(19) United States
(12) Patent Application Publication
(10) Pub. No.: US 2013/0119296 A1
(43) Pub. Date: May 16, 2013

(54) Methods for Providing Surface Treatments in a Magnetic Field

(71) Applicants: Gerard M. Ludtka, Oak Ridge, TN (US); Leonid V. Budaragin, Moscow (RU); Mark A. Deininger, Roswell, GA (US); Michael M. Pozvonkov, Cumming, GA (US); D. Morgan Spears, II, Atlanta, GA (US); Paul D. Fisher, Landis, NC (US)

(72) Inventors: Gerard M. Ludtka, Oak Ridge, TN (US); Leonid V. Budaragin, Moscow (RU); Mark A. Deininger, Roswell, GA (US); Michael M. Pozvonkov, Cumming, GA (US); D. Morgan Spears, II, Atlanta, GA (US); Paul D. Fisher, Landis, NC (US)

(73) Assignees: UT-BATTELLE, LLC, Oak Ridge, TN (US); C3 INTERNATIONAL, LLC, Atlanta, GA (US)

(21) Appl. No.: 13/641,135

(22) PCT Filed: Apr. 15, 2011
(86) PCT No.: PCT/US2011/032773

§ 371 Date: Jan. 29, 2013

Related U.S. Application Data
(60) Provisional application No. 61/324,925, filed on Apr. 16, 2010.

(51) Int. Cl. B05D 3/00

(52) U.S. Cl. CPC B05D 3/207
USPC 252/62.51 R; 423/592.1; 252/182.33; 427/547; 427/543; 205/199

(57) ABSTRACT

The invention relates to methods for creating metal oxide coatings on one or more surfaces employing a magnetic field, and articles containing those coatings. Such methods involve contacting the surfaces to be treated with a metal compound, and converting the metal compound to metal oxide for example by heating the surfaces to the desired temperature in the presence of a magnetic field. The magnetic field dramatically improves, in some embodiments, the characteristics of the metal oxide coating.

### CROSS-REFERENCE TO RELATED APPLICATIONS

The present application claims benefit of priority under PCT Article 8 and 35 U.S.C. §119(e) of U.S. Provisional Application No. 61/324,925, filed on Apr. 16, 2010, entitled, “METHODS FOR PROVIDING SURFACE TREATMENTS IN A MAGNETIC FIELD.” That provisional application is incorporated herein by reference in its entirety.

### STATEMENT REGARDING FEDERALLY SPONSORED RESEARCH OR DEVELOPMENT

The Government has rights in this invention pursuant to Work for Others Agreement No. NFE-06-00473.

### BACKGROUND OF THE INVENTION

1. Field of the Invention

This invention relates to methods for providing surface treatments on various surfaces under the influence of a magnetic field. Those surface treatments in some embodiments cause a coating to form on the surface, which coating may improve one or more properties of the surface, such as, for example, corrosion resistance, abrasion resistance, electrical properties, magnetic properties, and optical properties. In some embodiments, the surface treatment provides a coating that imparts new functionality to the surface, for example, when a coating independently or in concert with the surface exhibits behavior not observed from the untreated surface.

2. Description of Related Art

It is known to treat certain materials in a magnetic field, with or without heat, using devices such as those disclosed and claimed in U.S. Pat. No. 7,161,124 B2, to Kisner et al. That patent describes, among other things, devices comprising a magnet and providing or removing thermal energy from a workpiece that comprises at least one electrically conductive material. The '124 patent is hereby incorporated by reference in its entirety.

It is also known that treatment of a workpiece, for example steel, in a magnetic field even at mild temperatures can relieve residual stresses, as described in U.S. Pat. No. 6,773,513 B2 to Ludtka. When a steel workpiece is subjected to ambient temperatures in a magnetic field of strength 6 T, in one embodiment, surface axial residual stresses are measurably reduced. The '513 patent is also incorporated by reference in its entirety.

Methods for forming metal oxide coatings on cutting tools appear in U.S. Pat. No. 7,211,292 B1 to Budaragin. That patent describes, in some embodiments, depositing a composition containing at least one metal carboxylate on the surface of the cutting tool, and then heating the cutting tool to transform the metal carboxylate into the corresponding metal oxide. The '292 patent is hereby incorporated by reference in its entirety.

### SUMMARY OF THE INVENTION

Some embodiments of the present invention provide a method for forming at least one metal oxide on a surface, comprising:

applying at least one metal compound to the surface;

subjecting the at least one metal compound to an environment that will convert at least some of the at least one metal compound to at least one metal oxide,

wherein the environment comprises a magnetic field.

Other embodiments of the present invention provide a surface comprising at least one metal oxide, wherein the surface has been subjected to a process comprising:

applying at least one metal compound to the surface;

subjecting the at least one metal compound to an environment that will convert at least some of the at least one metal compound to at least one metal oxide,

wherein the environment comprises a magnetic field.

Still other embodiments provide at least one metal oxide, wherein the at least one metal oxide has been formed according to a process comprising:

applying at least one metal compound to a surface;

subjecting the at least one metal compound to an environment that will convert at least some of the at least one metal compound to at least one metal oxide,

wherein the environment comprises a magnetic field.

Some embodiments provide a method for forming at least one metal oxide on a surface, comprising:

applying at least one metal compound to the surface;

providing at least one magnetic field to the surface; and

subjecting the at least one metal compound to an environment that will convert at least some of the at least one metal compound to at least one metal oxide. The applying and providing can be performed in any chronological order.

### DETAILED DESCRIPTION OF SPECIFIC EMBODIMENTS

As used herein, the term “rare earth metal” includes those metals in the lanthanide series of the Periodic Table, including lanthanum. The term “transition metal” includes metals in Groups 3-12 of the Periodic Table (but excludes rare earth metals). The term “metal compound” particularly as used in conjunction with the above terms includes any compound that can form or be prepared from the metal, irrespective of whether it is naturally occurring or not. The “metal” atoms of the metal compounds of the present invention are not necessarily limited to those elements that form metallic phases in the pure form. “Metal compounds” include substances such as molecules comprising at least one metal atom and at least one oxygen atom. Metal compounds can be converted into metal oxides by exposure to a suitable environment for a suitable amount of time.

As used herein, the term “phase deposition” includes any coating process onto a substrate that is subsequently followed by the exposure of the substrate and the coating material to an environment that causes a phase change in either the coating material, one or more components of the coating material, or of the substrate itself.

The term alkyl, as used herein, refers to a saturated straight, branched, or cyclic hydrocarbon, or a combination thereof, including but not limited to C₁ to C₂₄, methyl, ethyl, n-propyl, isopropyl, n-butyl, isobutyl, t-butyl, n-pentyl, cyclopentyl, isopentyl, neopentyl, n-hexyl, isohexyl, cyclohexyl, 3-methylpentyl, 2,2-dimethylbutyl, 2,3-dimethylbutyl, heptyl, octyl, nonyl, and decyl.

The term alkoxy, as used herein, refers to a saturated straight, branched, or cyclic hydrocarbon, or a combination thereof, including but not limited to C₁ to C₂₄, methyl, ethyl, n-propyl, isopropyl, n-butyl, isobutyl, t-butyl, n-pentyl, cyclopentyl, isopentyl, neopentyl, n-hexyl, isohexyl, cyclohexyl, 3-methylpentyl, 2,2-dimethylbutyl, 2,3-dimethylbutyl, heptyl, octyl, nonyl, and decyl, in which the hydrocarbon contains a single-bonded oxygen atom that can bond to or is bonded to another atom or molecule.

The terms alkenyl and alkynyl, as used herein, refer to straight, branched, or cyclic hydrocarbon with at least one double or triple bond, respectively, including but not limited to C₁ to C₂₄.

The term aryl or aromatic, as used herein, refers to monocyclic or bicyclic hydrocarbon ring molecule having conjugated double bonds about the ring, and includes but is not limited to 5- to 12-membered ring molecules. The ring may be unsubstituted or substituted having one or more alike or different independently-chosen substituents, wherein the substituents are chosen from alkyl, alkenyl, alkynyl, alkoxy, hydroxyl, and amino radicals, and halogen atoms. Aryl includes, for example, unsubstituted or substituted phenyl and unsubstituted or substituted naphthyl.

The term heteroaryl as used herein refers to a five- to twelve-membered monocyclic or bicyclic aromatic hydrocarbon ring having at least one heteroatom chosen from O, N, P, and S as a member of the ring, and the ring is unsubstituted or substituted with one or more alike or different independently-chosen substituents chosen from alkyl, alkenyl, alkynyl, hydroxyl, alkoxy, amino, alkylamino, dialkylamino, thiol, alkylthio, ═O, ═NH, ═PH, ═S, and halogen atoms. Heteroaryl includes, but is not limited to, 5- to 12-membered ring molecules.

The term hydrocarbon refers to molecules that contain carbon and hydrogen.

Some embodiments of the present invention provide metal compounds that can convert into metal oxides. In some embodiments, metal compounds that form metal oxides include metal carboxylates, metal alkoxides, and metal β-diketonates.

A. Metal Carboxylates

The metal salts of carboxylic acids useful in the present invention can be made from any suitable carboxylic acids according to methods known in the art. For example, U.S. Pat. No. 5,952,769 to Budaragin discloses suitable carboxylic acids and methods of making metal salts of carboxylic acids, among other places, at columns 5-6. The disclosure of U.S. Pat. No. 5,952,769 is incorporated herein by reference. In some embodiments, the metal carboxylate can be chosen from metal salts of 2-hexanoic acid. Moreover, suitable metal carboxylates can be purchased from chemical supply companies. For example, cerium(III) 2-ethylhexanoate, magnesium(II) stearate, manganese(II) cyclohexanebutyrate, and zinc(II) methacrylate are available from Sigma-Aldrich of St. Louis, Mo. See Aldrich Catalogue, 2005-2006. Additional metal carboxylates are available from, for example, Alfa-Aesar of Ward Hill, Mass.

The metal carboxylate composition, in some embodiments of the present invention, comprises one or more metal salts of one or more carboxylic acid (“metal carboxylate”). Metal carboxylates suitable for use in the present invention include at least one metal atom and at least one carboxylate radical —OC(O)R bonded to the at least one metal atom. As stated above, metal carboxylates can be produced by a variety of methods known to one skilled in the art. Non-limiting examples of methods for producing the metal carboxylate are shown in the following reaction schemes:

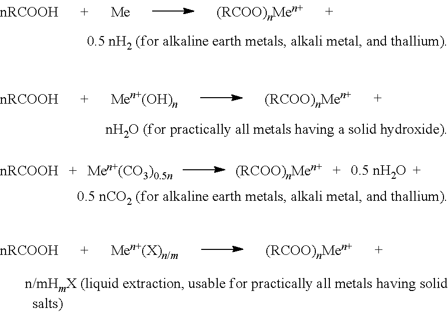

In the foregoing reaction schemes, X is an anion having a negative charge m, such as, e.g., halide anion, sulfate anion, carbonate anion, phosphate anion, among others; n is a positive integer; and Me represents a metal atom.

R in the foregoing reaction schemes can be chosen from a wide variety of radicals. Suitable carboxylic acids for use in making metal carboxylates include, for example:

### Monocarboxylic Acids:

Monocarboxylic acids where R is hydrogen or unbranched hydrocarbon radical, such as, for example, HCOOH—formic, CH₃COOH—acetic, CH₃CH₂COOH—propionic, CH₃CH₂CH₂COOH(C₄H₈O₂)—butyric, C₅H₁₀O₂—valeric, C₆H₁₂O₂—caproic, C₇H₁₄—enanthic; further: caprylic, pelargonic, undecanoic, dodecanoic, tridecylic, myristic, pentadecylic, palmitic, margaric, stearic, and nonadecylic acids;

Monocarboxylic acids where R is a branched hydrocarbon radical, such as, for example, (CH₃)₂CHCOOH—isobutyric, (CH₃)₂CHCH₂COOH—3—methylbutanoic, (CH₃)₃CCOOH—trimethylacetic, including VERSATIC 10 (trade name) which is a mixture of synthetic, saturated carboxylic acid isomers, derived from a highly-branched C₁₀ structure;

Monocarboxylic acids in which R is a branched or unbranched hydrocarbon radical containing one or more double bonds, such as, for example, CH₂═CHCOOH—acrylic, CH₃CH═CHCOOH—crotonic, CH₃(CH₂)₇CH═CH(CH₂)₇COOH—oleic, CH₃CH═CHCH═CHCOOH—hexa-2,4-dienoic, (CH₃)₂C═CHCH₂CH₂C(CH₃)═CHCOOH—3,7-dimethylocta-2,6-dienoic, CH₃(CH₂)₄—CH═CHCH₂CH═CH(CH₂)₇COOH—linoleic, further: angelic, tiglic, and elaidic acids;

Monocarboxylic acids in which R is a branched or unbranched hydrocarbon radical containing one or more triple bonds, such as, for example, CH≡CCOOH—propiolic, CH₃C≡CCOOH—tetrolic, CH₃(CH₂)₄C≡CCOOH—oct-2-ynoic, and stearolic acids;

Monocarboxylic acids in which R is a branched or unbranched hydrocarbon radical containing one or more double bonds and one or more triple bonds;

Monocarboxylic acids in which R is a branched or unbranched hydrocarbon radical containing one or more double bonds and one or more triple bonds and one or more aryl groups;

Monohydroxymonocarboxylic acids in which R is a branched or unbranched hydrocarbon radical that contains one hydroxyl substituent, such as, for example, HOCH₂COOH—glycolic, CH₃CHOHCOOH—lactic, C₆H₅CHOHCOOH—amygdalic, and 2-hydroxybutyric acids;

Dihydroxymonocarboxylic acids in which R is a branched or unbranched hydrocarbon radical that contains two hydroxyl substituents, such as, for example, (HO)₂CHCOOH—2,2-dihydroxyacetic acid;

Dioxycarboxylic acids, in which R is a branched or unbranched hydrocarbon radical that contains two oxygen atoms each bonded to two adjacent carbon atoms, such as, for example, C₆H₃(OH)₂COOH—dihydroxy benzoic, C₆H₂(CH₃)(OH)₂COOH—orsellinic; further: caffeic, and piperic acids;

Aldehyde-carboxylic acids in which R is a branched or unbranched hydrocarbon radical that contains one aldehyde group, such as, for example, CHOCOOH—glyoxalic acid;

Keto-carboxylic acids in which R is a branched or unbranched hydrocarbon radical that contains one ketone group, such as, for example, CH₃COCOOH—pyruvic, CH₃COCH₂COOH—acetoacetic, and CH₃COCH₂CH₂COOH—levulinic acids;

Monoaromatic carboxylic acids, in which R is a branched or unbranched hydrocarbon radical that contains one aryl substituent, such as, for example, C₆H₅COOH—benzoic, C₆H₅CH₂COOH—phenylacetic, C₆H₅CH(CH₃)COOH—2-phenylpropanoic, C₆H₅CH═CHCOOH—3-phenylacrylic, and C₆H₅CCCOOH—3-phenyl-propiolic acids;

### Multicarboxylic Acids:

Saturated dicarboxylic acids, in which R is a branched or unbranched saturated hydrocarbon radical that contains one carboxylic acid group, such as, for example, HOOC—COOH—oxalic, HOOC—CH₂—COOH—malonic, HOOC—(CH₂)₂—COOH—succinic, HOOC—(CH₂)₃—COOH—glutaric, HOOC—(CH₂)₄—COOH—adipic; further: pimelic, suberic, azelaic, and sebacic acids;

Unsaturated dicarboxylic acids, in which R is a branched or unbranched hydrocarbon radical that contains one carboxylic acid group and at least one carbon-carbon multiple bond, such as, for example, HOOC—CH═CH—COOH—fumaric; further: maleic, citraconic, mesaconic, and itaconic acids;

Polybasic aromatic carboxylic acids, in which R is a branched or unbranched hydrocarbon radical that contains at least one aryl group and at least one carboxylic acid group, such as, for example, C₆H₄(COOH)₂—phthalic (isophthalic, terephthalic), and C₆H₃(COOH)₃—benzyl-tri-carboxylic acids;

Polybasic saturated carboxylic acids, in which R is a branched or unbranched hydrocarbon radical that contains at least one carboxylic acid group, such as, for example, ethylene diamine N,N′-diacetic acid, and ethylene diamine tetraacetic acid (EDTA);

### Polybasic Oxyacids:

Polybasic oxyacids, in which R is a branched or unbranched hydrocarbon radical containing at least one hydroxyl substituent and at least one carboxylic acid group, such as, for example, HOOC—CHOH—COOH—tartronic, HOOC—CHOH—CH₂—COOH—malic, HOOC—C(OH)═CH—COOH—oxaloacetic, HOOC—CHOH—CHOH—COOH—tartaric, and HOOC—CH₂—C(OH)COOH—CH₂COOH—citric acids.

In some embodiments, the monocarboxylic acid comprises one or more carboxylic acids having the formula I below:

R—C(R″)(R′)—COOH (I)

wherein:
R is selected from H or C₁ to C₂₄ alkyl groups; and
R′ and R″ are each independently selected from H and C₁ to C₂₄ alkyl groups;
wherein the alkyl groups of R, R′, and R″ are optionally and independently substituted with one or more substituents, which are alike or different, chosen from hydroxy, alkoxy, amino, heteroaryl, and aryl radicals, and halogen atoms.

Some suitable alpha branched carboxylic acids typically have an average molecular weight in the range 130 to 420. In some embodiments, the carboxylic acids have an average molecular weight in the range 220 to 270. The carboxylic acid may also be a mixture of tertiary and quaternary carboxylic acids of formula I. VIK acids can be used as well. See U.S. Pat. No. 5,952,769, at col. 6, 11.12-51.

Either a single carboxylic acid or a mixture of carboxylic acids can be used to form the metal carboxylate composition. In some embodiments, a mixture of carboxylic acids is used. In still other embodiments, the mixture contains 2-ethylhexanoic acid where R is H, R″ is C₂H₅ and R′ is C₄H₉. In some embodiments, this acid is the lowest boiling acid constituent in the mixture. When a mixture of metal carboxylates is used, the mixture has a broader evaporation temperature range, making it more likely that the evaporation temperature of the mixture will overlap the metal carboxylate decomposition temperature, allowing the formation of a solid metal oxide coating. Moreover, the possibility of using a mixture of carboxylates avoids the need and expense of purifying an individual carboxylic acid.

B. Metal Alkoxides

Metal alkoxides suitable for use in the present invention include at least one metal atom and at least one alkoxide radical —OR² bonded to the at least one metal atom. Such metal alkoxides include those of formula II:

M(OR²)_{z} (II)
in which M is a metal atom of valence z+;
z is a positive integer, such as, for example, 1, 2, 3, 4, 5, 6, 7, and 8;
R² is chosen from unsubstituted and substituted alkyl, unsubstituted and substituted alkenyl, unsubstituted and substituted alkynyl, unsubstituted and substitutes heteroaryl, and unsubstituted and substituted aryl radicals, and combinations thereof, wherein substituted alkyl, alkenyl, alkynyl and aryl radicals are substituted with one or more substituents chosen from halogen, hydroxy, alkoxy, amino, heteroaryl, aryl radicals, and combinations thereof.
In some embodiments, z is chosen from 2, 3, and 4.

Metal alkoxides are available from Alfa-Aesar and Gelest, Inc., of Morrisville, Pa. Lanthanoid alkoxides such as those of Ce, Nd, Eu, Dy, and Er are sold by Kojundo Chemical Co., Saitama, Japan, as well as alkoxides of Al, Zr, and Hf, among others. See, e.g., http://www.kojundo.co.jp/English/Guide/material/lanthagen.html.

Examples of metal alkoxides useful in embodiments of the present invention include methoxides, ethoxides, propoxides, isopropoxides, and butoxides and isomers thereof. The alkoxide substituents on a give metal atom are the same or different. Thus, for example, metal dimethoxide diethoxide, metal methoxide diisopropoxide t-butoxide, and similar metal alkoxides can be used. Suitable alkoxide substituents also may be chosen from:
1. Aliphatic series alcohols from methyl to dodecyl including branched and isostructured.
2. Aromatic series alcohols: benzyl alcohol —C₆H₅CH₂OH; phenyl-ethyl alcohol —C₈H₁₀O; phenyl-propyl alcohol —C₉H₁₂O, and so on.

Metal alkoxides useful in the present invention can be made according to many methods known in the art. One method includes converting the metal halide to the metal alkoxide in the presence of the alcohol and its corresponding base. For example:

MX_{z}+zHOR²→M(OR²)_{z}+zHX

in which M, R², and z are as defined above for formula II, and X is a halide anion.

C. Metal β-Diketonates

Metal β-diketonates suitable for use in the present invention contain at least one metal atom and at least one β-diketone of formula III as a ligand:

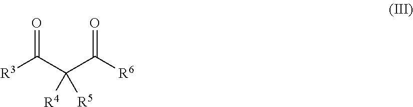

in which
R³, R⁴, R⁵, and R⁶ are alike or different, and are independently chosen from hydrogen, unsubstituted and substituted alkyl, unsubstituted and substituted alkoxy, unsubstituted and substituted alkenyl, unsubstituted and substituted alkynyl, unsubstituted and substituted heteroaryl, unsubstituted and substituted aryl, carboxylic acid groups, ester groups having unsubstituted and substituted alkyl, and combinations thereof,
wherein substituted alkyl, alkoxy, alkenyl, alkynyl, heteroaryl, and aryl radicals are substituted with one or more substituents chosen from halogen atoms, hydroxy, alkoxy, amino, heteroaryl, and aryl radicals.

It is understood that the β-diketone of formula III may assume different isomeric and electronic configurations before and while chelated to the metal atom. For example, the free β-diketone may exhibit enolate isomerism. Also, the β-diketone may not retain strict carbon-oxygen double bonds when the molecule is bound to the metal atom.

Examples of β-diketones useful in embodiments of the present invention include acetylacetone, trifluoroacetylacetone, hexafluoroacetylacetone, 2,2,6,6-tetramethyl-3,5-heptanedione, 6,6,7,7,8,8,8-heptafluoro-2,2-dimethyl-3,5-octanedione, ethyl acetoacetate, 2-methoxyethyl acetoacetate, benzoyltrifluoroacetone, pivaloyltrifluoroacetone, benzoyl-pyruvic acid, and methyl-2,4-dioxo-4-phenylbutanoate.

Other ligands are possible on the metal 3-diketonates useful in the present invention, such as, for example, alkoxides such as —OR² as defined above, and dienyl radicals such as, for example, 1,5-cyclooctadiene and norbornadiene.

Metal β-diketonates useful in the present invention can be made according to any method known in the art. β-diketones are well known as chelating agents for metals, facilitating synthesis of the diketonate from readily available metal salts.

Metal β-diketonates are available from Alfa-Aesar and Gelest, Inc. Also, Strem Chemicals, Inc. of Newburyport, Mass., sells a wide variety of metal β-diketonates on the internet at http://www.strem.com/code/template.ghc?direct=cvdindex.

A magnetic field can be applied, in various embodiments of the present invention, by any suitable means. One or more permanent magnets, superconducting magnets, electromagnets, and the like can apply static, pulsed, or variable magnetic fields to the surface on which the metal oxide coating forms. Bar magnets, horseshoe magnets, button magnets, quadrupoles, alternating focusing and defocusing quadrupoles, other multipoles, torroidal magnets, wire loops, solenoids, and the like, alone and in combination, can be used to supply the magnetic field. For example, one or more solenoids can surround the workpiece, so the workpiece is positioned inside the loops of the solenoids. In another example, multiple solenoids can be positioned about a workpiece, so the workpiece is positioned outside the loops of the solenoids. While the magnetic field inside the loops of a solenoid may be stronger and more uniform than the magnetic field outside the loops of the solenoid, it may be more convenient for some workpieces to use the external field of a plurality of solenoids, such as, for example, large pipes and assembled fluid processing or transport systems. Optionally, the external field of one or more solenoids is enhanced, for example, by including a paramagnetic material within the loops of the solenoid. The magnetic field is applied during the conversion of the at least one metal compound to the at least one metal oxide. The magnetic field also can be applied before and/or after the conversion.

The magnetic field can be any suitable shape. In some embodiments, the magnetic field is substantially uniform in strength, and the magnetic field lines are substantially straight and parallel to each other, in the vicinity of the surface being coated. In other embodiments, the magnetic field can be curved in the vicinity of the surface being coated. In still other embodiments, the magnetic field lines can be substantially parallel to the surface. Other embodiments provide magnetic field lines that are substantially normal to the surface being coated. Yet other embodiments provide magnetic field lines that form an angle with the surface that is neither 90° (normal) or 0° (parallel). In still other embodiments, the surface being coated is not flat, such that the orientation of the magnetic field relative to the surface cannot be described simply. For example, a pipe elbow could be placed in a magnetic field formed by a large torroidal (ring-shaped) superconducting magnet, metal compound is deposited in the interior of the pipe elbow, and the metal compound is then converted.

The magnetic field can be any suitable strength. In some embodiments, the magnetic field is less than one Tesla. In still further embodiments, the magnetic field ranges from about 1 Tesla to about 2 Tesla, from about 2 Tesla to about 4 Tesla, from about 4 Tesla to about 6 Tesla, from about 6 Tesla to about 8 Tesla, from about 8 Tesla to about 10 Tesla, or greater than about 10 Tesla.

Some devices for applying suitable magnetic fields appear, for example, U.S. Pat. No. 7,161,124 B2 to Kisner et al., which has been incorporated by reference herein. Devices for applying suitable magnetic fields optionally provide one or more of heating, cooling, vacuum, fluid flushing, and manipulating means to the substrate being coated. Some embodiments provide a quartz vessel for holding one or more components to be coated in a magnetic field. Such a vessel, in some embodiments, contains one or more means for holding components so that evacuating, applying a magnetic field, heating, and cooling do not dislodge the components. Such means for holding components include quartz structures in the vessel that immobilize the components being coated. Care should be taken so that components are not permitted to accelerate by the application of a large magnetic field. Quartz and similar materials that are not affected by strong magnetic fields or higher temperatures are suitable for some embodiments.

In other embodiments, materials such as soft magnetic materials and paramagnetic materials can be used alone or in combination, for various purposes, such as enclosing the component to be coated so that a vacuum or inert atmosphere may be created, holding the component in place, and/or enhancing the magnetic field about the surface during conversion. In still other embodiments, paramagnetic, diamagnetic, ferromagnetic, ferrimagnetic, and antiferromagnetic materials can be used, alone or in combination, for various purposes such as adjusting the magnetic field about the surface during conversion. Such adjusting may include strengthening, weakening, and/or shaping the magnetic field. Similarly, more than one magnet can be used to apply the magnetic field, and those magnets can be aligned in parallel, antiparallel, perpendicularly, askew, or a combination thereof. Also, suitable materials can be used to aid in heating the conversion environment, for example, via induction heating of metallic-conducting material. In some embodiments, such materials can be heated, for example by laser radiation, thereby indirectly heating the environment to cause conversion.

In some embodiments, methods of the invention can include a pre-application cleaning step prior to the application of the at least one metal compound. In these embodiments, the invention involves the application of one or more cleaning materials, which may be in vapor, liquid, semi-solid phase, or a combination of these to at least a portion of the surface to be coated, followed by a flushing and drying cycle at a drying temperature. The cleaning technique can be of the type used for cleaning surfaces prior to coating, plating, painting, or similar surface treatments. The pre-application cleaning step may also include a pickling operation using known chemicals and process in order to prepare the surface(s) for coating.

The surface to be treated according to the invention also can be pretreated, in further embodiments, before the application of the composition. In some cases, the surface can be etched according to known methods, for example, with an acid wash comprising nitric acid, sulphuric acid, hydrochloric acid, phosphoric acid, or a combination of two or more thereof, or with a base wash comprising sodium hydroxide or potassium hydroxide, for example. In further cases, the surface can be mechanically polished, with or without the aid of one or more chemical etching agents, abrasives, and polishing agents, to make the surface either rougher or smoother. In still further cases, the surface can be pretreated such as by carburizing, nitriding, painting, powder coating, plating, or anodizing. Thin films of chrome, tin, and other elements, alone or in combination, can be deposited, in some embodiments. Methods for depositing thin films are well known and include chemical vapor deposition, physical vapor deposition, molecular beam epitaxy, plasma spraying, electroplating, ion impregnation, and others.

In some embodiments of the present invention, a metal compound comprises a transition metal atom. In other embodiments, a metal compound comprises a rare earth metal atom. In further embodiments, the metal compound composition comprises a plurality of metal compounds. In some embodiments, a plurality of metal compounds comprises at least one rare earth metal compound and at least one transition metal compound. Metal carboxylates, metal alkoxides, and metal β-diketonates can be chosen for some embodiments of the present invention.

In further embodiments, a metal compound mixture comprises one metal compound as its major component and one or more additional metal compounds which may function as stabilizing additives. Stabilizing additives, in some embodiments, comprise trivalent metal compounds. Trivalent metal compounds include, but are not limited to, chromium, iron, manganese, and nickel compounds. A metal compound composition, in some embodiments, comprises both cerium and chromium compounds.

In some embodiments, the metal compound that is the major component of the metal compound composition contains an amount of metal that ranges from about 65 to about 97% by weight or from about 80 to about 87% by weight of the total weight of metal in the composition. In other embodiments, the amount of metal forming the major component of the metal compound composition ranges from about 90 to about 97% by weight of the total metal present in the composition. In still other embodiments, the amount of metal forming the major component of the metal compound composition ranges from about 97 to about 100% by weight of the total metal present in the composition.

The metal compounds that may function as stabilizing additives may be present in amounts, in some embodiments, such that the total amount of the metal in metal compounds which are the stabilizing additives is at least 3% by weight, relative to the total weight of the metal in the metal compound composition. This can be achieved in some embodiments by using a single stabilizing additive, or multiple stabilizing additives, provided that the total weight of the metal in the stabilizing additives is greater than 3%. In other embodiments, the total weight of the metal in the stabilizing additives ranges from about 3% to about 35% by weight. In still other embodiments, the total weight for the metal in the stabilizing additives ranges from about 3 to about 30% by weight, relative to the total weight of the metal in the metal compound composition. In other embodiments, the total weight range for the metal in the stabilizing additives ranges from about 3 to about 10% by weight. In some embodiments, the total weight range for the metal in the stabilizing additives is from about 7 to about 8% by weight, relative to the total weight of the metal in the metal compound composition.

The amount of metal in the metal compound composition, according to some embodiments, ranges from about 20 to about 150 grams of metal per kilogram of metal compound composition. In other embodiments, the amount of metal in the metal compound composition ranges from about 30 to about 50 grams of metal per kilogram of metal compound composition. In further embodiments, the metal compound composition can contain from about 30 to about 40 grams of metal per kg of composition. Amounts of metal less than 20 grams per kilogram of metal compound composition or greater than about 150 grams of metal per kilogram of metal compound composition also can be used.

The metal compound may be present in any suitable composition. Finely divided powder, nanoparticles, solution, suspension, multi-phase composition, gel, aerosol, and paste, among others, are possible.

The metal compound composition may also include nanoparticles in the size range of equal to or less than 100 nm in average size and being composed of a variety of elements or combination thereof, for example, Al₂O₃, CeO₂, Ce₂O₃, TiO₂, ZrO₂ and others. Core-shell nanoparticles are also contemplated. In some embodiments, a ferromagnetic nanoparticle coated with a weakly diamagnetic material can be included. In other embodiments, a weakly diamagnetic material forms the core, while a ferromagnetic material forms the shell. In some cases, the nanoparticles can be dispersed, agglomerated, or a mixture of dispersed and agglomerated nanoparticles. Nanoparticles may have a charge applied to them, negative or positive, to aid dispersion. Moreover, dispersion agents, such as known acids or surface modifying agents, may be used. The presence of nanoparticles may decrease the porosity of the final coating; the level of porosity will generally decrease with increasing quantity and decreasing size of the included nanoparticles. Coating porosity can also be influenced by applying additional coating layers according to the process of the invention; porosity will generally decrease with an increasing number of layers. In some embodiments the nanoparticles may be first mixed with a liquid and then mixed with the compound composition; this method provides a means to create a fine dispersion in a first liquid which retains its dispersion when mixed with a second, or third liquid. For example, nanoparticles of chosen elements, molecules, or alloys may be dispersed into a first liquid and, after a desired quality of dispersion is achieved, the nanoparticles in the first liquid may be mixed with the liquid metal compound composition prior to the exposure of the final composition to an environment that will convert at least a portion of the metal compound(s) into metal oxides. The result may be a more dense film with reduced porous sites.

The applying of the metal compound composition may be accomplished by various processes, including dipping, spraying, flushing, vapor deposition, printing, lithography, rolling, spin coating, brushing, swabbing (e.g., with an absorbent “pig” of fabric or other material that contains the metal compound composition and is drawn through the apparatus), or any other means that allows the metal compound composition to contact the desired portions of the surface to be treated. In this regard, the metal compound composition may be liquid, and may also comprise a solvent. The optional solvent may be any hydrocarbon and mixtures thereof. In some embodiments, the solvent can be chosen from carboxylic acids; toluene; xylene; benzene; alkanes, such as for example, propane, butane, isobutene, hexane, heptane, octane, and decane; alcohols, such as methanol, ethanol, n-propanol, isopropanol, n-butanol, and isobutanol; mineral spirits; β-diketones, such as acetylacetone; ketones such as acetone; high-paraffin, aromatic hydrocarbons; and combinations of two or more of the foregoing. Some embodiments employ solvents that contain water in trace amounts or greater, while other embodiments employ water as the solvent. In some embodiments, the metal compound composition further comprises at least one carboxylic acid.

The metal compound composition can applied in some embodiments in which the composition has a temperature less than about 250° C. That composition also can be applied to the substrate in further embodiments at a temperature less than about 50° C. In other embodiments, the metal compound composition is applied to the substrate at room temperature. In still other embodiments, the metal compound composition is applied to the substrate below room temperature.

Following application, the at least one metal compound is at least partially converted to at least one metal oxide. In some embodiments the at least one metal compound is fully converted to at least one metal oxide.

Suitable environments for converting the at least one metal compound into at least one metal oxide include vacuum, partial vacuum, atmospheric pressure, high pressure equal to several atmospheres, high pressure equal to several hundred atmospheres, inert gases, and reactive gases such as gases comprising oxygen, including pure oxygen, air, dry air, and mixtures of oxygen in various ratios with one or more other gases such as nitrogen, carbon dioxide, helium, neon, and argon, as well as hydrogen, mixtures of hydrogen in various ratios with one or more other gases such as nitrogen, carbon dioxide, helium, neon, and argon, also other gases such as, for example nitrogen, NH₃, hydrocarbons, H₂₅, PH₃, each alone or in combination with various gases, and still other gases which may or may not be inert in the converting environment. That environment may be heated relative to ambient conditions, in some embodiments. In other embodiments, that environment may comprise reactive species that cause or catalyze the conversion of the metal compound to the metal oxide, such as, for example, acid-catalyzed hydrolysis of metal alkoxides. In still other embodiments, the metal compound is caused to convert to the metal oxide by the use of induction heating or lasers, as explained below.

The conversion environment may be accomplished in a number of ways. For example, a conventional oven may be used to bring the coated substrate up to a temperature exceeding approximately 400° C. but less than 500° C. for a chosen period of time. In other embodiments, the environment of the coated substrate is heated to a temperature ranging from about 400° C. to about 650° C. In further embodiments, the environment is heated to a temperature ranging from about 400° C. to about 550° C. In still further embodiments, the environment is heated to a temperature ranging from about 550° C. to about 650° C., from about 650° C. to about 800° C., or from about 800° C. to about 1000° C. Depending on the size of the substrate to be coated, the time period may be extended such that sufficient conversion of a desired amount of the metal compound to metal oxides has been accomplished.

In some applications, the oxidation of the surface being treated is not desired. In these cases, an inert atmosphere may be provided in the conversion environment to prevent such oxidation. In the case of heating the component in a conventional oven, a nitrogen or argon atmosphere can be used, among other inert gases, to prevent or reduce the oxidation of the surface prior to or during the conversion process.

The conversion environment may also be created using induction heating through means familiar to those skilled in the art of induction heating. Alternatively, the conversion environment may be provided using a laser applied to the surface area for sufficient time to allow at least some of the metal compounds to convert to metal oxides. In other applications, the conversion environment may be created using an infra-red light source which can reach sufficient temperatures to convert at least some of the metal compounds to metal oxides. Some embodiments may employ a microwave emission device to cause at least some of the metal compound to convert. In the case of induction heating, microwave heating, lasers, and other heating methods that can produce the necessary heat levels in a short time, for example, within 10 minutes, 20 minutes, 30 minutes, 40 minutes, or one hour. Accordingly, in some embodiments, the conversion environment can be created without the use of an inert gaseous environment, thus enabling conversion to be done in open air, outside of a closed system due to the reduced time for undesirable compounds to develop on the material's surface in the presence of ambient air.

The gas above the metal compound on the surface can be heated, in some embodiments, to convert the metal compound to the metal oxide. Heating can be accomplished by introducing high temperature gases, which contact the surface having the at least one metal compound to be converted to the desired metal oxide(s). This high temperature gas can be produced by a conventional oven, induction heating coils, heat exchangers, industrial process furnaces, exothermic reactions, microwave emission, or other suitable heating method.

If there are surfaces on which it is not desired to have a metal oxide coating formed (e.g. fluid beds, catalytic surfaces, etc.), these can be temporarily bypassed using known methods of piping, valves, ports, etc. during one or more steps of the method of the invention, be it during the application of a composition to the inner surfaces or during the high temperature conversion stage, or a combination thereof. Likewise, areas that are to be kept free of the coating of the invention can be masked-off using known means prior to the application of the method's composition and its conversion using some heat or energy source.

In other applications, the metal compound composition may be applied to chosen areas of a component or system and an induction heating element may be passed proximate to the area of interest to create the conversion environment. In some applications, the inner surface of a component may not be visible by line of sight, but an induction wand held proximate to the outside surfaces of the component may allow sufficient heat to be developed on the wetted surfaces being treated with the metal compounds such that the desired oxides are formed by an indirect heating method. This technique would also be possible using infra-red heating from outside of a component, flame heating, or other known heating methods wherein the material of the component can be raised to the desired temperature to ensure the conversion of the metal compounds to oxides. Using this method of indirect heating may also be used with a chosen atmosphere that may be provided proximate to the wetted surfaces of the pipe or component, such as an inert atmosphere made up of argon, as one example, which would serve to prevent undesirable compounds to form on the material surface being treated.

In other applications, multiple coats comprising one or more metal oxides may be desired. To reduce the time between applications of the coating of the invention, cooling methods may be used after each heating cycle to bring the surfaces to the required temperatures prior to subsequent applications of the metal compounds. Such cooling methods may be used that are known to the art such as water spraying, cold vapor purging through the interior of the system, evaporative cooling methods, and others.

Representative coating compositions that have been found to be suitable in embodiments of the present invention include, but are not limited to:

ZrO₂, for example, at 0-90 wt %

CeO₂, for example, at 0-90 wt %

CeO₂—ZrO₂, for example, where CeO₂ is about 10-90 wt %

Y₂O₃ and Yttria-stabilized Zirconia, for example, where Y is about 1-50% mol %

TiO₂, for example, at 0-90 wt %

Fe₂O₃, for example, at 0-90 wt %

NiO, for example, at 0-90 wt %

Al₂O₃, for example, at 0-90 wt %

Cr₂O₃

Mo₂O₃

HfO₂

La₂O₃

Pr₂O₃

Nd₂O₃

Sm₂O₃

Eu₂O₃

Gd₂O₃

Tb₂O₃

Dy₂O₃

Ho₂O₃

Er₂O₃

Tm₂O₃

Yb₂O₃

Lu₂O₃

Mixtures of these compositions are also suitable for use in the invention. In some embodiments, oxides of cerium and samarium are formed such that cerium is present in an amount of approximately 50 atomic percent, while samarium is present in an amount of approximately 10 atomic percent. In other embodiments, oxides of iron and zirconium are formed such that zirconium is present in an amount of approximately 30 atomic percent, and iron is present in an amount of approximately 10 atomic percent.

Compounds, for example, oxides, carbides, nitrides, sulfides, and phosphides of the following elements also can be used in embodiments of the present invention: Lithium, Beryllium, Sodium, Magnesium, Aluminum, Silicon, Potassium, Calcium, Scandium, Titanium, Vanadium, Chromium, Manganese, Iron, Cobalt, Nickel, Copper, Zinc, Gallium, Germanium, Arsenic, Bromine, Rubidium, Strontium, Yttrium, Zirconium, Niobium, Molybdenum, Technetium, Ruthenium, Rhodium, Palladium, Antimony, Tellurium, Silver, Cadmium, Indium, Tin, Cesium, Barium, Lanthanum, Cerium, Praseodymium, Neodymium, Promethium, Samarium, Europium, Gadolinium, Terbium, Dysprosium, Holmium, Erbium, Thulium, Ytterbium, Lutetium, Hafnium, Tantalum, Tungsten, Rhenium, Osmium, Iridium, Platinum, Gold, Mercury, Thallium, Lead, Bismuth, Radium, Actinium, Thorium, Protactinium, Uranium, Neptunium, Plutonium, Americium, Curium, Berkelium, Californium, Einsteinium, Fermium, Mendelevium, Nobelium, and Lawrencium. Compounds containing more than one of the foregoing elements, and compounds containing elements in addition to the foregoing elements, also can be used in embodiments of the present invention. For example, SrTiO₃ and MgAl₂O₄ are included. Those materials are likely to form at least in small amounts when appropriate metal salts such as metal compounds are used, depending on the conditions of the conversion process. Typically, the molar ratio of metal compounds deposited on the surface corresponds to the molar ratio of metal oxides after conversion.

In some embodiments of the present invention, species that are susceptible to a magnetic field can be included as, in, and/or with the metal compounds. For example, the metal compound can include one or more metal atoms that exhibit a response to a magnetic field. Atoms and atomic ions containing one or more unpaired electrons exhibit paramagnetism, and tend to be drawn into a magnetic field, while atoms and atomic ions having all electrons paired are considered diamagnetic and are weakly repelled by a magnetic field. Both paramagnetic and diamagnetic atoms, ions, complexes, and molecules can be used in various embodiments of the invention.

In other embodiments, other magnetically susceptible ingredients, such as magnetic particles, metal particles, metal-containing particles, and combinations thereof can be deposited on the surface on which the metal oxide coating will form. Ferromagnetism refers to those materials having multiple magnetic moments, all of which align together to exhibit a net magnetic field. Ferrimagnetic materials also exhibit a net magnetic field, but some of the internal magnetic moments are aligned against the net magnetic field. Antiferromagnets exhibit zero net magnetic field due to anti-alignment of internal magnetic moments.

In still other embodiments, the resulting at least one metal oxide itself exhibits one or more magnetic properties. Those properties may be caused by the application of the magnetic field, or they can arise for other reasons. In some embodiments of the present invention, the at least one metal oxide is diamagnetic, paramagnetic, ferromagnetic, ferrimagnetic, or antiferromagnetic, or, where possible, exhibits a combination of those properties. For example, certain metal oxides having perovskite structure exhibit magnetic moments. In some embodiments, those magnetic moments align parallel, antiparallel, or randomly to the applied magnetic field, or combinations thereof. Spin glasses, such as those comprising multiple nanocrystalline domains, appear in other embodiments of the present invention.

The invention relates, in some embodiments, to diffused coatings and thin films (and articles coated therewith) containing at least one rare earth metal oxide, and at least one transition metal oxide. As used herein, “diffused” means that metal oxide molecules, nanoparticles, nanocrystals, larger domains, or more than one of the foregoing, have penetrated the substrate. The diffusion of metal oxides can range in concentration from rare interstitial inclusions in the substrate, up to the formation of materials that contain significant amounts of metal oxide. A thin film is understood to indicate a layer, no matter how thin, composed substantially of metal oxide. In some embodiments, a thin film has very little or no substrate material present, while in other embodiments, a thin film comprises atoms, molecules, nanoparticles, or larger domains of substrate ingredients. In some embodiments, it may be possible to distinguish between diffused portions and thin films. In other embodiments, a gradient may exist in which it becomes difficult to establish a boundary between the diffused coating and the thin film. Furthermore, some embodiments may exhibit only one of a diffused coating and a thin film. Additional embodiments provide contiguous domains of metal oxide on a substrate, while other embodiments provide non-contiguous domains, for example, for catalytic applications. Still other embodiments include thin films in which one or more species have migrated from the substrate into the thin film. The term “metal oxide” includes all of those possibilities, including diffused coatings, thin films, stacked thin films, contiguous and non-contiguous domains, and combinations thereof. The term “metal oxide coating” includes, for example, diffused coatings, thin films, stacked thin films, and combinations thereof.

As explained herein, the diffused coating of some embodiments of the invention provides increased performance, in part, because it penetrates the surface of the coated substrate to a depth, usually around 200 to 600 Angstroms, providing a firm anchor to the material being coated without the need for intermediate bonding layers. This allows much thinner films [in some embodiments around 0.1 to 1 microns in thickness (or about 0.5 microns when approximately 6 layers are used)] to be applied, and yet may provide equivalent protection to that provided by conventional coating or thin film technologies. This, in turn, allows for thinner films or coatings to be established, reducing significantly the cost of materials attaching to the substrate. Thus, some embodiments of the present invention provide a thin film no thicker than about 5 nm. Other embodiments provide a thin film no thicker than about 10 nm. Still other embodiments provide a thin film no thicker than about 20 nm. Still other embodiments provide a thin film no thicker than about 100 nm. Still other embodiments provide a thin film having a thickness ranging from about 100 nm to about 200 nm, about 200 nm to about 500 nm, about 500 nm to about 1 micron, about 1 micron to about 1.5 microns, about 1.5 microns to about 2 microns, about 2 microns to about 5 microns, about 5 microns to about 10 microns, and greater than about 10 microns.

In some embodiments of the invention, the metal oxide coating can contain other species, such as, for example, species that have migrated from the substrate into the metal oxide coating. In other embodiments, those other species can come from the atmosphere in which the at least one metal compound is converted. For example, the conversion can be performed in an environment in which other species are provided via known vapor deposition methods. Still other embodiments provide other species present in or derived from the at least one metal compound or the composition comprising the metal compound. Suitable other species include metal atoms, metal compounds including those metal atoms, such as oxides, nitrides, carbides, sulfides, phosphides, and mixtures thereof, and the like. The inclusion of other species can be accomplished, in some embodiments, by controlling the conditions during conversion, such as the use of a chosen atmosphere during the heat conversion process, for example, a partial vacuum or atmosphere containing O₂, N₂, NH₃, one or more hydrocarbons, H₂S, alkylthiols, PH₃, or a combination thereof.

In addition, the effect of any mismatches in physical, chemical, or crystallographic properties (particularly with regard to differences in thermal expansion coefficients) may be minimized by the use of much thinner coating materials and the resulting films. Furthermore, the smaller crystallite structure of the film (3-6 nanometers, in some embodiments) increases Hall-Petch strength in the film's structure significantly.

In some embodiments, the present invention provides methods of reducing differences in coefficients of thermal expansion between a substrate and a metal oxide coating proximal to the substrate. In some embodiments, methods of reducing differences in coefficients of thermal expansion between a substrate and at least one metal oxide comprise interposing a diffused coating between the substrate and the metal oxide. Interposing such a diffused coating comprises applying at least one metal compound to the substrate, and then at least partially converting the at least one metal compound to at least one metal oxide.

The nanocrystalline grains resulting from some embodiments of the methods of the present invention have an average size of less than about 50 nm. In some embodiments, nanocrystalline grains of metal oxide have an average size ranging from about 1 nm to about 40 nm or from about 5 nm to about 30 nm. In other embodiments, nanocrystalline grains have an average size ranging from about 10 nm to about 25 nm. In further embodiments, nanocrystalline grains have an average size of less than about 10 nm, or less than about 5 nm.

In other embodiments, the invention relates to metal oxide coatings (whether diffused, thin film, or both diffused and thin film) and articles comprising such coatings, in which the coatings contain two or more rare earth metal oxides and at least one transition metal oxide. Further embodiments of the invention relate to metal oxide coatings (and articles comprising them), containing ceria, a second rare earth metal oxide, and a transition metal oxide. Some embodiments relate to metal oxide coatings (and articles comprising them), containing yttria, zirconia, and a second rare earth metal oxide. In some cases, the second rare earth metal oxide can include platinum or other known catalytic elements.

In some embodiments, the metal compound applied to the surface comprises a cerium compound, and the metal oxide coating comprises cerium oxide (or ceria). In other embodiments, the metal compound applied to the surface comprises a zirconium compound, and the metal oxide coating comprises zirconia. In yet other embodiments, a solution comprising both a cerium compound and a zirconium compound is applied, and the resulting metal oxide coating comprises ceria and zirconia. In some cases, the zirconia formed by the process of the invention comprises crystal grains having an average size of about 3-9 nm, and the ceria formed by the process of the invention comprises crystal grains having an average size of about 9-18 nm. The nanostructured zirconia can be stabilized in some embodiments with yttria or other stabilizing species alone or in combination.

In additional embodiments, other treatments can be performed after the formation of a compound coating. As explained herein, additional metal oxide coatings, which can be the same or different, can be added. In some embodiments, the metal oxide(s) can be etched, polished, carburized, nitrided, painted, powder coated, plated, or anodized. In some embodiments, the at least one metal oxide coating serves as a bond coat for at least one additional coating. Such additional coatings need not be formed according to the present invention. For example, one or more additional metal oxide coats can be formed in the absence of a magnetic field. Some embodiments provide a metal oxide bond coat that allows an additional coating that would not adhere to the surface as well in the absence of the bond coat. In addition, the substrate can be subjected to a thermal treatment, either before or after a metal oxide coating is formed on the substrate. For example, a substrate having a metal oxide coating in accordance with the present invention can be annealed at high temperature to strengthen the substrate. In another example, a substrate can be held near absolute zero before or after a metal oxide coating is formed on the substrate. Suitable temperatures for thermal treatment range from nearly 0 K to several thousand K, and include liquid hydrogen, liquid helium, liquid neon, liquid argon, liquid krypton, liquid xenon, liquid radon, liquid nitrogen, liquid oxygen, liquid air, and solid carbon dioxide temperatures, and temperatures obtained by mixtures and azeotropes of those and other materials. Such thermal treatments can be applied in the presence or absence of a magnetic field.

In some embodiments of the present invention, various magnetic properties can be enhanced or limited by the application of appropriate temperatures along with a magnetic field. For example, a composition comprising the at least one metal compound can be applied to the surface, and the temperature of the environment can be adjusted to enhance or limit a magnetic property of one or more ingredients of the composition, the surface, or both. For example, the temperature can be raised or lowered relative to a given Curie temperature, Neel temperature, or temperature at which superdiamagnetism, superparamagnetism, metamagnetism, or spin glass behavior appears. Alternatively, the environment can be preset to the desired temperature, before the composition comprising the at least one metal compound is applied to the surface. In some embodiments, a magnetic field is applied while the environment has the desired temperature. In other embodiments, a magnetic field is applied before the environment has achieved the desired temperature. Then the at least one metal compound is converted into the at least one metal oxide in the presence of a magnetic field, in some embodiments. In still other embodiments, temperature can enhance or limit various magnetic properties of the at least one metal oxide, another ingredient, the surface, or a combination thereof, after converting the at least one metal compound to the at least one metal oxide. For example, the environment can be held at a given temperature for a suitable time, with or without applying a magnetic field.

In those embodiments of the present invention employing more than one layer of at least one metal oxide, various combinations of temperature and magnetic field treatments can be utilized in forming the several layers. For example, one layer of at least one metal oxide can result from one set of temperature and magnetic field treatments, while another layer can result from a different set of temperature and magnetic field treatments. In some embodiments, several layers of metal oxide can be fabricated in which each layer exhibits a different orientation of net magnetic field. This can be accomplished, for example, by converting subsequent coatings of the at least one metal compound with the surface oriented in different directions relative to the magnetic field. In other embodiments, the temperatures of applying the at least one metal compound, and before, during, and after conversion can be the same or different. In still other embodiments, the magnetic field strength, orientation, and dynamic characteristics (such as, whether the applied magnetic field varies, pulses, changes orientation, or remains steady) can be the same or different for each layer.

The methods of the present invention can be used during or after manufacturing a given component. For example, one or more compound coatings can be applied to a component's surface as it is manufactured, or after the component is assembled into a system. Moreover, in some embodiments, the methods of the present invention can be incorporated into conventional manufacturing steps. For example, after two metal components are welded together, often they are subjected to a heat treatment to relieve the stresses introduced by the welding process. In some embodiments of the present invention, at least one metal compound is applied after welding and before that heat treatment. In those embodiments, that one heat treatment converts at least one metal compound into at least one metal oxide and relieves welding-induced stresses. A magnetic field also can be applied as described in U.S. Pat. No. 6,773,513 B2, and the component benefits from the thermal treatment and the magnetic field treatment during the conversion process, as well as from the metal oxide coating, in some embodiments.

The process of the invention may permit the use of coatings on a wide variety of materials, including application of CeO₂ and ZrO₂ coatings to ceramics and/or solid metals previously not thought possible of being coated with these materials. Some embodiments of the present invention provide a relatively low temperature process that does not damage or distort many substrates, does not produce toxic or corrosive water materials, and can be done on site, or “in the field” without the procurement of expensive capital equipment.

Additionally, the nature of the resulting interstitial boundaries of the invention's nanocrystalline structures in various embodiments can be comprised of chosen ingredients so as to increase ionic conductivity while decreasing electron conductivity, or can be comprised of chosen ingredients so as to increase the material's mixed conductivity, or to modify its porosity. In a similar fashion, many other properties may be altered through the judicious selection of various ingredients that are formulated as part of the metal compound composition of the invention.

In some embodiments of the present invention, a substrate which comprises at least a portion of a component's structure is placed within a vacuum chamber, and the chamber is evacuated. Vapor of one or more metal compounds, such as cerium(IV) 2-hexanoate, enters the vacuum chamber and deposits on the substrate. A specific volume of a fluid composition containing the metal compound can provide a specific amount of compound to the surface of the substrate within the vacuum chamber, depending on the size of the chamber and other factors. A magnetic field is applied about the substrate, for example, by positioning a superconducting torroidal magnet about the substrate, and by passing sufficient current through the magnet to achieve a desired magnetic field. The magnet may be positioned inside or outside the vacuum chamber, and in some embodiments is protected from the atmosphere and temperature of the vacuum chamber. A chosen gas is vented into the chamber and fills the vacuum chamber to a chosen pressure, in one example, equal to one atmosphere, and the chamber is heated to a temperature sufficient to convert at least some of the compounds into oxides, for example, 450° C., for a discrete amount of time sufficient for the conversion process, for example, thirty minutes. In this example, a ceria layer forms on the substrate. Optionally, the chamber can be evacuated again and the process repeated as many times as desired, forming a thicker coating of ceria on the substrate. In some embodiments, the component can be cooled relative to ambient temperature, such as, for example, to liquid nitrogen temperature, to aid the deposition process. In other embodiments, a reducing atmosphere may be used to convert at least a portion of the metal oxides to metal.

In other embodiments, the substrate can comprise one or more polymers, such as polyvinyl chloride. The polymer substrate can be kept at lower temperatures sufficient to prevent the degradation of the substrate during the heating process, for example, at liquid nitrogen temperatures while the metal compound converts to the oxide due to any technique that heats the metal compound but not the substrate to a significant degree. Examples of such heating techniques include flash lamps, lasers, and microwave heating. In addition, materials that would become degraded by exposure to high temperatures can be kept at lower temperatures using the same techniques. For example, glasses, low-melting-temperature metals, polycarbonates, and similar substrates can be kept cooler while the at least one metal compound is converted to at least one metal oxide.

As used herein in reference to process gases used to carry out the process of the invention, the term “high temperature” means a temperature sufficiently high to convert the metal compound to metal oxide, generally in the range of about 200° C. to about 1000° C., such as, for example, about 200° C. to about 400° C., or about 400° C. to about 500° C., about 500° C. to about 650° C., about 650° C. to about 800° C., or about 800° C. to about 1000° C. Process gases at even higher temperatures can be used, so that, when the gas is passed through an apparatus during the process of some embodiments of the invention, the temperature of the gas exiting the system is within the range given above.

A given embodiment of the invention described herein may involve one or more of several basic concepts. For example, one concept relates to a surface treatment that generally meets above-described technical properties and can be manufactured at a low cost. Another concept relates to a method to form a metal oxide protective film on the surface of a metal. Another concept relates to a two-step process adapted to form a prophylactic layer onto internal surfaces of an apparatus or system. Another concept relates to creating thin films of nanocrystalline zirconia on surfaces. Another concept is related to a means to apply a protective coating to an assembly of various components using a process to heat an enclosed system as a curing method for the coating. Another concept relates to forming a coating of at least one metal oxide in the presence of a magnetic field.

In some embodiments of the invention, an oxidizing coating may be formed on a substrate by applying a liquid metal compound composition to the substrate using a dipping process, spraying, vapor deposition, swabbing, brushing, or other known means of applying a liquid to a surface.

This liquid metal compound composition comprises at least one rare earth metal salt of a carboxylic acid and at least one transition metal salt of a carboxylic acid, in a solvent, in some embodiments. The surface, once wetted with the composition is then exposed to a heated environment in the presence of a magnetic field that will convert at least some of the metal compounds to metal oxides, thereby forming an oxidizing coating on the substrate.

The metal oxide coatings resulting from the conversion process, such as thin films of nanocrystalline materials, are applied to material substrates to form one or more thin layers. Additional applications of the metal compounds followed by conversion environment exposure (e.g., heating the surface through means described above) may be done to create multiple layers of thin film compound coatings stacked one on another.

The process may be used to create a nanocrystalline structure that comprises an heteroatom-containing molecule for chosen applications. Alternately, the resulting nanocrystalline structure may comprise a metal containing compound, a metal, a ceramic, or a cermet.

One benefit to some embodiments of the invention is the ability to apply the metal compound composition to an assembled system and then to flush high temperature gases through the system to achieve the conversion process, resulting in a well-dispersed metal oxide coating on all interior surfaces. This is especially beneficial for welded piping systems, heat exchangers, and similar components which use welding for their assembly, said welding typically destroying whatever surface treatments were applied to the pipes, heat exchangers, or other parts prior to welding. The high temperature conditions of the welding process tend to destroy all protective coatings. The invention provides a way to create a final metal oxide coating covering all parts of the process system, creating a protective coating for weld joints and component interiors alike. In those embodiments, a magnetic field is applied to the entire system, or at least part of the system, with any suitable means. Such means include, for example, one or more solenoids positioned about the portion of the system on which the at least one metal compound will be converted to at least one metal oxide.

To create a less porous thin film, for some embodiments, material may be added to the base fluid to act as filler material. In this way, the porosity of the finished coating is altered through the inclusion of nanoparticles of chosen elements in the liquid metal compound composition prior to the exposure of the composition to an environment that will convert at least a portion of the metal compound(s) into metal oxides. The result may be a more dense thin film.

In some applications, where it is desirable to reduce a metal oxide to a pure metal, the treated substrate may be exposed to a reducing agent, such as hydrogen or other known reducing agent using known means for oxide reduction. For example, 7% hydrogen in argon heated to 350° C. can be used to form platinum in certain embodiments. Other metals that may be desired, such as for catalytic purposes, for example, include but are not limited to platinum, palladium, rhodium, nickel, cerium, gold, silver, zinc, lead, rhenium, ruthenium, and combinations of two or more thereof. Such reduction may take place with or without the application of a magnetic field.

The materials that can be protected according to the present invention include any material that can receive a protective coating of a metal oxide. Such materials include, for example, metals, ceramics, glasses, and cermets, as well as composites and polymers that can withstand the process conditions for converting the metal carboxylate into metal oxide.

The industrial and commercial products that can be coated according to the present invention are not limited. Petroleum refinery; petrochemical processing; petroleum transport and storage such as pipelines oil tankers, fuel transport vehicles, and gas station fuel tanks and pumps; industrial chemical manufacture, storage, and transportation; automotive fluid systems including fuel systems, lubrication systems, radiators, air heaters and coolers, break systems, power steering, and similar hydraulics systems; aeronautical and aerospace fluid storage and transport systems including fuel systems and hydraulic systems; and food and dairy processing systems; among many others, can benefit from the present invention.

As previously stated, detailed embodiments of the present invention are disclosed herein; however, it is to be understood that the disclosed embodiments are merely exemplary of the invention that may be embodied in various forms. It will be appreciated that many modifications and other variations that will be appreciated by those skilled in the art are within the intended scope of this invention as claimed below without departing from the teachings, spirit, and intended scope of the invention. Furthermore, the foregoing description of various embodiments does not necessarily imply exclusion. For example, “some” embodiments may include all or part of “other” and “further” embodiments within the scope of this invention.

We claim:

1. A method for forming at least one metal oxide on a surface, comprising:
applying at least one metal compound to the surface;
subjecting the at least one metal compound to an environment that will convert at least some of the at least one metal compound to at least one metal oxide, wherein the environment comprises a magnetic field.

2. The method of claim 1, wherein the magnetic field is a static magnetic field.

3. The method of claim 1, wherein the magnetic field is a pulsed magnetic field.

4. The method of claim 1, wherein the magnetic field is a variable magnetic field.

5. The method of claim 1, wherein the magnetic field is substantially uniform in the vicinity of the surface.

6. The method of claim 1, wherein the magnetic field has a strength greater than about 10 Tesla.

7. The method of claim 1, wherein the subjecting comprises induction heating under an inert atmosphere.

8. The method of claim 1, wherein the subjecting comprises induction heating in a vacuum.

9. The method of claim 1, wherein the subjecting comprises induction heating in an atmosphere comprising oxygen.

10. A method for forming at least one metal oxide on a surface, comprising:
applying at least one metal compound to the surface;
providing at least one magnetic field to the surface; and
subjecting the at least one metal compound to an environment that will convert at least some of the at least one metal compound to at least one metal oxide.

11. The method of claim 10, further comprising pretreating the surface before the applying.

12. The method of claim 11, wherein the pretreating is chosen from carburizing, nitriding, painting, powder coating, plating, anodizing, and combinations thereof.

13. A surface comprising at least one metal oxide, wherein the surface has been subjected to a process comprising:
applying at least one metal compound to the surface;
subjecting the at least one metal compound to an environment that will convert at least some of the at least one metal compound to at least one metal oxide, wherein the environment comprises a magnetic field.

14. The surface of claim 13, wherein the surface comprises a plurality of metal oxides.

15. The surface of claim 13, wherein the surface comprises at least one rare earth metal oxide and at least one transition metal oxide.

16. The surface of claim 13, wherein the at least one metal oxide penetrates the surface.

17. The surface of claim 16, wherein the at least one metal oxide penetrates the surface to a depth from about 200 to about 600 Angstroms.

18. A metal oxide, wherein the metal oxide has been formed according to a process comprising:
applying at least one metal compound to a surface;
subjecting the at least one metal compound to an environment that will convert at least some of the at least one metal compound to the metal oxide, wherein the environment comprises a magnetic field.

19. The metal oxide of claim 18, wherein the surface comprises at least one rare earth metal oxide and at least one transition metal oxide.

20. The metal oxide of claim 18, further comprising at least one nanoparticle.
